(19) United States
(12) Patent Application Publication
(10) Pub. No.: US 2002/0167450 A1
(43) Pub. Date: Nov. 14, 2002

(54) Mobile data carrier including a transponder having a surface wave component and a slot antenna

(75) Inventors: Christian Korden, Munich (DE); Thomas Ostertag, Geretsried (DE); Werner Pfeifer, Nuernberg (DE); Gerd Scholl, Munich (DE)

Correspondence Address: SUGHRUE MION, PLLC, 2100 Pennsylvania Avenue, NW, Washington, DC, 20037-3213, US

(73) Assignee: SIEMENS AG

(21) Appl. No.: 10/146,911

(22) Filed: May 17, 2002

Related U.S. Application Data
(63) Continuation of application No. PCT/DE00/04092, filed on Nov. 20, 2000.

(30) Foreign Application Priority Data
Nov. 18, 1999 (DE) DE 299 20 240.2
Nov. 18, 1999 (DE) DE 199 55 707.1

(51) Int. Cl. H01Q 13/10

(52) U.S. Cl. 343/767; 343/768

(57) ABSTRACT

A mobile data carrier (1) including a transponder having a slot antenna (2) and a surface wave component (3), which serves as transmitter and/or receiver and which is electrically connected to the slot antenna (2). It is of advantage that the slot antenna (2) includes an antenna sheet (21) and an antenna slot (22), and that the surface wave component (3) has electrical contactors (31, 32), which are electrically connected to the left and right of the antenna slot (22). The surface wave component (3) is preferably fixed to the underside (213) of the antenna sheet (21). An additional, preferably electrically-conducting base plate (5) is mounted on the above-described arrangement with spacers (41, 42).

This is a Continuation of International Application PCT/DE00/04092, with an international filing date of Nov. 20, 2000, which was published under PCT Article 21(2) in German, and the disclosure of which is incorporated into this application by reference.

### FIELD AND BACKGROUND OF THE INVENTION

The present invention relates to a mobile data carrier, which is, for instance, fixed to cargo and functions as an identification tag. The mobile data carrier includes a transponder having a surface wave (SW) component, in particular an SW-identification tag or an SW-sensor, and an antenna arrangement. Through such a transponder, the mobile data carrier is capable of emitting data. Thus, the data of the mobile data carrier can be read contactlessly, e.g., by external reading stations, and can be updated, where applicable.

German laid-open patent application DE 197 09 847 A1 discloses a control system for a mobile unit and a method for the operation thereof. In order to locate and transmit information within a semi-automatically or fully-automatically operated transport and trans-shipment process, this control system includes at least one interrogator, which is carried by the mobile unit, and a plurality of stationary transponders that are distributed over a movement area.

It is known in the art to provide a transponder, which includes a surface wave component, with a so-called patch antenna. This patch antenna is a flat conductor structure arranged on an epoxy, RT/Duroid, or Teflon substrate. Such antennas have several drawbacks. One substantial drawback is that the performance of a thus constructed transponder is limited, in particular in the proximity of metal surfaces. Furthermore, the operability of such transponders may be limited at elevated temperatures, e.g., at >100° C. Thus, a mobile data carrier having a transponder of this type is preferably used in an environment where no or only few metallic surfaces are present. For instance, such a transponder can be fixed to cardboard boxes or wooden crates.

### OBJECTS OF THE INVENTION

It is one object of the present invention to provide a mobile data carrier that obviates the above-mentioned problems of conventional transponders.

### SUMMARY OF THE INVENTION

According to one formulation of the invention, this and other objects are achieved by a mobile data carrier that includes a transponder having a flat slot antenna, which is electrically connected to a surface wave component. A plurality of spacers is mounted to an underside of the slot antenna. Further, a base plate, which has an electrically conductive surface, is mounted to the plurality of spacers. Advantageously, the slot antenna includes a metallic antenna sheet having an antenna slot. The surface wave component is preferably mounted to the underside of the antenna sheet. More specifically, the surface wave component is preferably mounted in an end area or a center area of the antenna slot. Therein, the two terminals of the surface wave component are connected to the underside of the antenna sheet on opposite sides of the antenna slot.

Such an arrangement offers various advantages. On the one hand, the slot antenna is produced at low cost, e.g., in the form of a simple stamped part using conventional sheet metal for the antenna sheet. In a simple manner, a radio-readable surface wave component, which is embodied as an SW-identification tag or an SW-sensor, is mounted and connected to the slot antenna, which serves as a metallic carrier. The mobile data carrier according to the invention has the particular advantage that it is cost-effectively produced, i.e., at low component and production costs. In addition, the data carrier according to the invention has other functional advantages. The overall arrangement according to the invention, which includes a surface wave component that is arranged under an antenna sheet having an antenna slot, can be used in the immediate proximity of metal surfaces as well as at elevated temperatures, e.g., at >200° C., without limiting its operability. In addition, the overall arrangement according to the invention offers particularly good values with respect to the transmission and reception range of the arrangement.

### BRIEF DESCRIPTION OF THE DRAWINGS

The invention will be described in greater detail with reference to the figures briefly identified below, in which:

FIG. 1 shows a top view of a first exemplary embodiment of a mobile data carrier according to the invention including a slot antenna having a preferably straight-line antenna slot;

FIG. 2 shows a side view of the mobile data carrier according to the embodiment shown in FIG. 1;

FIG. 3 shows a side view of another mobile data carrier, which, in supplement to the embodiment shown in FIG. 1, is provided with an additional, preferably metallic base plate mounted on spacer bolts;

FIG. 4 shows a top view of a second exemplary embodiment of a mobile data carrier according to the invention;

FIG. 5 shows a top view of a third exemplary embodiment of a mobile data carrier according to the invention, in which the antenna slot of the slot antenna extends in a straight line and is diagonally arranged on an antenna sheet; and

FIG. 6 shows a top view of a fourth exemplary embodiment of a mobile data carrier according to the invention, in which the antenna slot of the slot antenna is curved, for instance in the shape of an S.

### DETAILED DESCRIPTION OF THE PREFERRED EMBODIMENT

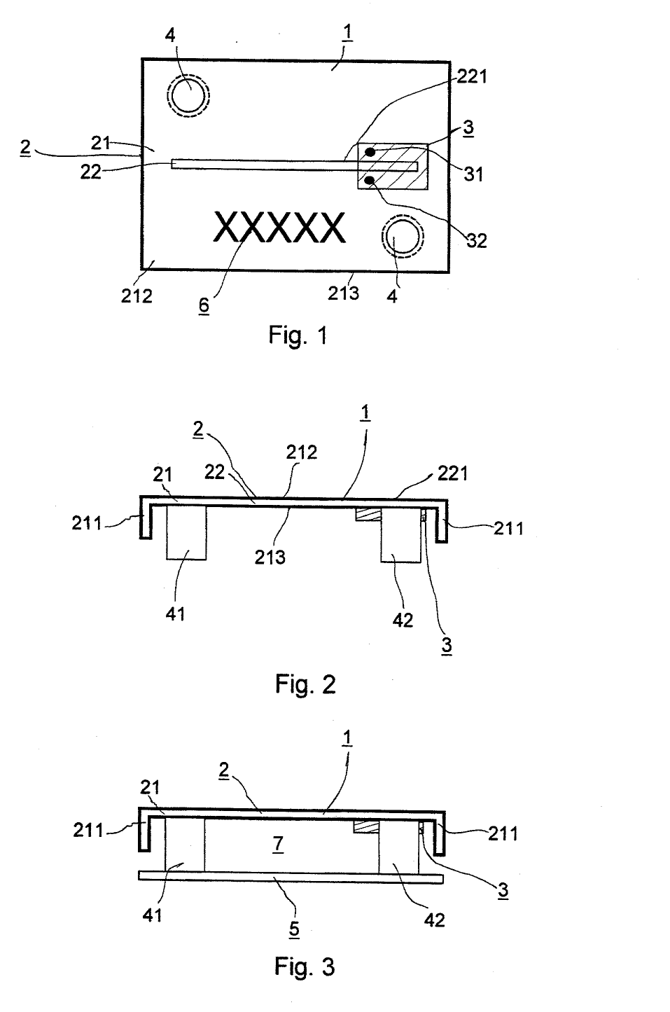

FIG. 1 shows a first exemplary embodiment of a mobile data carrier 1 according to the invention. This mobile data carrier has a transponder, which includes a slot antenna 2 and a surface wave (SW) component 3. Advantageously, the surface wave component 3 functions as an SW identification tag or an SW sensor.

In the preferred embodiment depicted in FIG. 1, the slot antenna 2 has a flat form, in particular a plate-shaped form. The slot antenna 2 includes a metallic antenna sheet 21 having an antenna slot 22. The length of the antenna slot 22 is a function of the operating frequency and the electrical load of the surface wave component 3. A value of 2.45 GHz is used, for example, as the operating frequency of the surface wave component 3. The length of the antenna slot 22 corresponds to approximately half the wavelength associated with this operating frequency.

The surface wave component 3 is advantageously mounted to an underside 213 of the antenna sheet 21. In the exemplary embodiment of FIG. 1, this is symbolized by a hatched representation of surface wave component 3. Furthermore, the surface wave component 3 is electrically connected via electrical contactors 31 and 32, at least one of which is located to the left and one to the right of the antenna slot 22. Finally, the antenna slot 22 is run, at least partially, across the surface wave component 3. Such an arrangement increases the mechanical protection of the surface wave component 3.

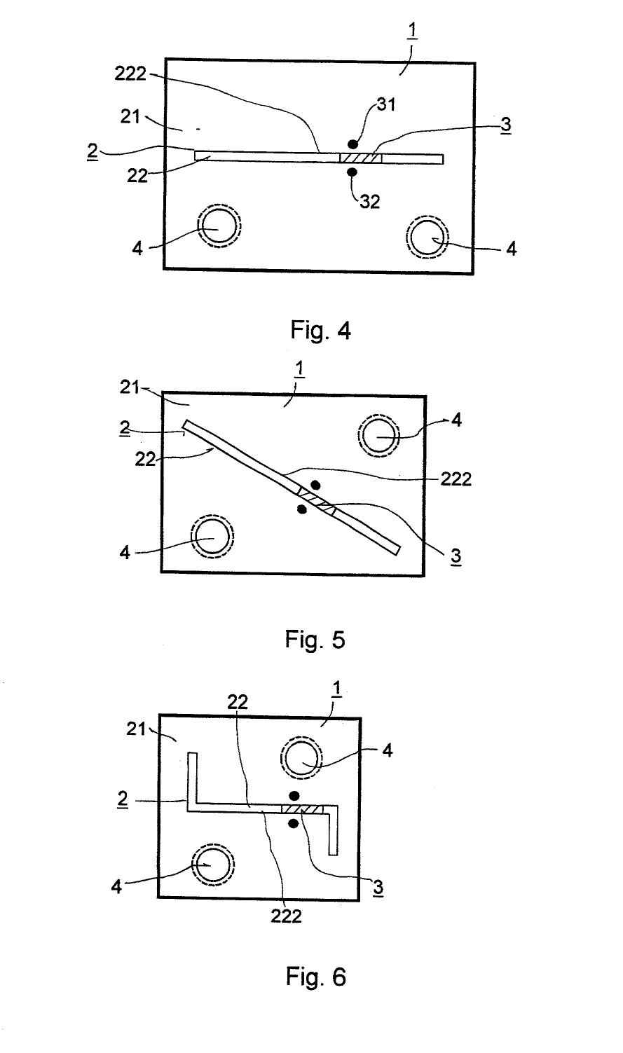

Depending on the input impedance of the surface wave component 3, the surface wave component 3 is positioned in an end area 221 or more toward a center area 222 of the slot antenna 2. In the exemplary embodiments of FIGS. 1 to 3, the surface wave component 3 is positioned at the end of the antenna slot 22, whereas, in the exemplary embodiments of FIGS. 4 to 6, the surface wave component 3 is positioned more toward the center 222 of the antenna slot 22.

FIGS. 2 and 3 show side views of the mobile data carrier 1 corresponding to the embodiment depicted in FIG. 1. According to these figures, edges 211 of the antenna sheet 21 are laterally angled at both ends of the antenna sheet 21 in a direction that is perpendicular to the antenna slot 22. These angled edges 211 impart rigidity to the antenna sheet 21 to ensure sufficient stability against bending of the antenna sheet 21 in the longitudinal direction of the antenna slot 22. The antenna sheet 21 can also be angled on all sides. Also, the laterally angled edges 211 improve the spatial emission behavior in the short range of the slot antenna 2.

Preferably, the antenna sheet 21 is fixed to a support by means of additional fasteners, e.g., by two screws. Additional spacers, e.g., two spacer bolts 4, are advantageously used to adjust a desired spacing between the support and the slot antenna 2. It is also possible to use more or fewer fastening elements.

It is of advantage if the surface of the support is electrically conductive, i.e., if it has at least a metallic coating. In this case, if the additional spacers 4 are also electrically conductive, i.e., if there is good electrical contact between the antenna sheet 21 and the metallic support, the emission behavior of the transponder of the inventive data carrier 1 is significantly improved. The metallic support causes the transmission energy to be reflected in the direction of an upper side 212 of the data carrier 1, so that the transmission range of the transponder is significantly increased. The plate-shaped antenna sheet 21 and the surface of the support are arranged approximately parallel to one another.

In a further exemplary embodiment, if the support, on which the mobile data carrier 1 is mounted, is not electrically conductive, an additional base plate 5 is arranged on the side of spacers 41, 42 facing away from the slot antenna 2, as shown in FIG. 3. Preferably, the base plate 5 is, at least on its surface, electrically conductive. In this case, the spacing between the antenna sheet 21 and the base plate 5 is adjusted by a suitable selection of the spacer bolts 41, 42, such that the transponder of the data carrier 1, i.e., the arrangement including the surface wave component 3 and the slot antenna 2, has the greatest possible reception and transmission range. In addition, a receptacle 7, which is protected against mechanical contact, is created for the surface wave component 3 on the underside 213 of the antenna sheet 21. The arrangement shown in FIG. 3 represents a particularly advantageous and compact unit. This unit is independent of the application purpose of the mobile data carrier 1 and thus, in particular, independent of the support, on which the data carrier is mounted. Irrespective of the application purpose, this unit has uniformly optimum reception and transmission properties, which are essentially due to the design and the mutual spatial arrangement of the antenna sheet 21 and the metallic base plate 5.

In exceptional cases, it may be necessary to identify the identification tag located on the surface wave component 3 even though the surface wave component 3 may have failed. To make this possible, the embodiments shown in FIG. 1 and FIG. 4 are provided with corresponding supplements. For instance, by embossing or stamping, or by a barcode or the like, an additional identification number 6 is applied to the topside of the antenna sheet 21. This number can be read by the human eye or by a camera having an image analysis capability.

The embodiments of the inventive mobile data carrier 1 shown in FIGS. 5 and 6 have the particular advantage that the slot antenna 2 of the transponder has an antenna sheet 21 that extends over a much smaller area. In the embodiment of FIG. 5, the antenna slot 22 is diagonal, whereas, in the embodiment of FIG. 6, it is, for instance, angled in Z-shape or S-shape. This makes it possible to significantly shorten the edge length of the antenna sheet 21 and, thus, the total dimensions of the data carrier 1. Therein, the embodiment having the Z-shaped antenna slot 22 according to FIG. 6 exhibits the shortest edge length.

According to the embodiment of FIG. 4, the slot antenna 2, which includes the antenna sheet 21 and the antenna slot 22, is asymmetrical.

Advantageously, the material used for the antenna sheet 21 of the slot antenna 2 has high conductivity. Aluminum, copper, tinplate, or steel are particularly suitable.

In another preferred embodiment, non-conductive materials having metallized surfaces are used as the base surface. Fundamentally, the base surface can be configured in any desired way. The surface is either advantageously fully or partially metallized. If the mobile data carrier 1 according to the invention is used in a so-called identification system, the base surface is formed, for example, by the outside of a piece of cargo.

Advantageously, the contact of the surface wave component 3 with the slot antenna 2 is accomplished by soldering, by a conductive adhesive, or by a combination of soldering and a non-conductive adhesive, which then serves for mechanical support only. If a high temperature solder is used, the identification tag can withstand temperatures of more than 200° C.

The optically readable identification number 6 is applied, for instance, by embossing or stamping, by a laser, by mechanical engraving, by applying a stamped or printed label, by direct ink jet printing, or the like.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A mobile data carrier including a transponder, comprising:
a flat slot antenna;
a plurality of spacers mounted to an underside of the slot antenna;
a base plate mounted to the plurality of spacers, wherein the base plate has an electrically conductive surface; and
a surface wave component, which is electrically connected with the slot antenna.

2. The mobile data carrier of claim 1, wherein the plurality of spacers comprise electrically conductive, metallic spacer bolts.

3. The mobile data carrier of claim 1, wherein the surface wave component comprises a surface wave identification tag.

4. The mobile data carrier of claim 1, wherein the surface wave component comprises a surface wave sensor.

5. The mobile data carrier of claim 4, wherein the slot antenna is plate-shaped.

6. The mobile data carrier of claim 1, wherein the surface wave component is mounted to the underside of the slot antenna.

7. The mobile data carrier of claim 1, wherein, depending of an input impedance of the surface wave component, the surface wave component is positioned either in a center area or in an end area of the slot antenna.

8. The mobile data carrier of claim 1, wherein the slot antenna has an antenna sheet including an antenna slot.

9. The mobile data carrier of claim 8, wherein the surface wave component has electrical contactors, which are electrically connected to the left and right of the antenna slot.

10. The mobile data carrier of claim 8, wherein the antenna slot extends, at least partially, across the surface wave component.

11. The mobile data carrier of claim 8, wherein the antenna sheet has laterally angled edges.

12. The mobile data carrier of claim 8, wherein the antenna slot is formed to extend diagonally in the antenna sheet.

13. The mobile data carrier of claim 8, wherein the antenna slot has an angled shape.

14. The mobile data carrier of claim 8, wherein the antenna slot is S-shaped.

15. The mobile data carrier of claim 1, wherein an interior of the base plate is also electrically conductive.

16. The mobile data carrier of claim 1, wherein the surface wave component is disposed in a space between the slot antenna and the base plate.

17. The mobile data carrier of claim 1, wherein length and width dimensions of the slot antenna are substantially equal to length and width dimensions of the base plate.
